(19) United States
(12) Patent Application Publication
(10) Pub. No.: US 2022/0049862 A1
(43) Pub. Date: Feb. 17, 2022

(54) ELEVATOR CAB AIR PURIFICATION

(71) Applicant: OTIS ELEVATOR COMPANY, Farmington, CT (US)

(72) Inventors: Patricia Derwinski, Farmington, CT (US); Cuauhtemoc Castro Inzunza, Florence, SC (US)

(21) Appl. No.: 16/994,884

(22) Filed: Aug. 17, 2020

(51) Int. Cl. F24F 3/16

(52) U.S. Cl. CPC F24F 3/161; F24F 2003/1667; F24F 3/166

(57) ABSTRACT

An illustrative example embodiment of an elevator cab air purification device includes a housing having an inlet, an outlet, and at least one air pathway between the inlet and the outlet. A fan module is situated to cause air flow into the housing through the inlet, through the housing, and out of the housing through the outlet. The air flow through the housing includes air flow along the at least one pathway in at least a first direction. An air purifier is situated within the housing and configured to purify air that flows along the at least one pathway before the air exits the housing through the outlet.

### BACKGROUND

Elevator systems typically include a cab for carrying passengers among various levels within a building. Many elevator cabs include a device for exchanging air between the interior of the cab and the hoistway. Such devices typically are limited in the amount of air flow or exchange that can be achieved. The limited air circulation provided by such devices and the unconditioned hoistway air typically inhibit such devices from easily addressing concerns about the purity of air in an elevator cab.

### SUMMARY

An illustrative example embodiment of an elevator cab air purification device includes a housing having an inlet, an outlet, and at least one air pathway between the inlet and the outlet. A fan module is situated to cause air flow into the housing through the inlet, through the housing, and out of the housing through the outlet. The air flow through the housing includes air flow along the at least one pathway in at least a first direction. An air purifier is situated within the housing and configured to purify air that flows along the at least one pathway before the air exits the housing through the outlet.

In an example embodiment having at least one feature of the device of the previous paragraph, the air purifier comprises a source of radiation.

In an example embodiment having at least one feature of the device of the any of the previous paragraphs, the source of radiation comprises a light that emits ultraviolet light.

In an example embodiment having at least one feature of the device of the any of the previous paragraphs, the at least one pathway includes a plurality of pathways, airflow along at least one of the pathways is in a second direction that is different than the first direction, and each of the pathways includes the source of radiation along at least portion of a length of the pathway.

In an example embodiment having at least one feature of the device of the any of the previous paragraphs, the first direction is opposite the second direction.

In an example embodiment having at least one feature of the device of the any of the previous paragraphs, the elevator cab includes a plurality of vertically oriented walls between a floor and a ceiling, the housing is situated parallel to and against at least one of the walls, the first direction corresponds to air flow away from the ceiling and toward the floor, and the second direction corresponds to air flow away from the floor and toward the ceiling.

In an example embodiment having at least one feature of the device of the any of the previous paragraphs, the housing includes a plurality of baffles that define the pathways within the housing.

In an example embodiment having at least one feature of the device of the any of the previous paragraphs, the fan module comprises a plurality of fans, and at least one of the plurality of fans is situated in a different location of the housing than at least one others of the plurality of fans.

In an example embodiment having at least one feature of the device of the any of the previous paragraphs, the housing is configured to be situated against a corner of an interior of the elevator cab.

In an example embodiment having at least one feature of the device of the any of the previous paragraphs, the housing is configured as a portion of an interior cab wall, a raised panel or a cabinet.

An illustrative example embodiment of a method of purifying air in an elevator cab uses a housing having an inlet, an outlet, and at least one air pathway between the inlet and the outlet. The method includes: causing air flow into the housing through the inlet, through the housing, and out of the housing through the outlet, wherein the air flow through the housing includes air flow along the at least one pathway in at least a first direction; and purifying air that flows along the at least one pathway before the air exits the housing through the outlet.

In an example embodiment having at least one feature of the method of the previous paragraphs, purifying the air comprises irradiating the air.

In an example embodiment having at least one feature of the method of the any of the previous paragraphs, irradiating the air comprises exposing the air to ultraviolet light.

In an example embodiment having at least one feature of the method of the any of the previous paragraphs, the at least one pathway comprises a plurality of pathways, airflow along at least one other of the pathways is in a second direction different from the first direction, and irradiating the air comprises exposing the air flow along each of the pathways to a light that emits the radiation along at least portion of a length of the pathway.

In an example embodiment having at least one feature of the method of the any of the previous paragraphs, the first direction is opposite the second direction.

In an example embodiment having at least one feature of the method of the any of the previous paragraphs, the elevator cab includes a plurality of vertically oriented walls between a floor and a ceiling, the housing is situated parallel to and against at least one of the walls, the first direction corresponds to air flow away from the ceiling and toward the floor, and the second direction corresponds to air flow away from the floor and toward the ceiling.

In an example embodiment having at least one feature of the method of the any of the previous paragraphs, the housing includes a plurality of baffles that define the pathways within the housing.

In an example embodiment having at least one feature of the method of the any of the previous paragraphs, causing the air flow comprises using a fan module, the fan module comprises a plurality of fans, and at least one of the plurality of fans is situated in a different location of the housing than at least one others of the plurality of fans.

In an example embodiment having at least one feature of the method of the any of the previous paragraphs, the housing is configured to be situated against a corner of an interior of the elevator cab.

In an example embodiment having at least one feature of the method of the any of the previous paragraphs, the housing is configured as a portion of an interior cab wall, a raised panel or a cabinet.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 diagrammatically illustrates selected portions of an example embodiment of an elevator cab including an example air purification device configuration.

FIG. 2 is a cross-sectional illustration taken along the lines 2-2 in FIG. 1.

FIG. 3 is an amplified view of the portion of FIG. 1 encircled at 3.

FIG. 4 diagrammatically illustrates selected portions of a fan module.

FIG. 5 diagrammatically illustrates another example embodiment of an elevator cab including an example air purification device configuration.

FIG. 6 schematically illustrates selected features of the air purification device configuration included in FIG. 5.

### DETAILED DESCRIPTION

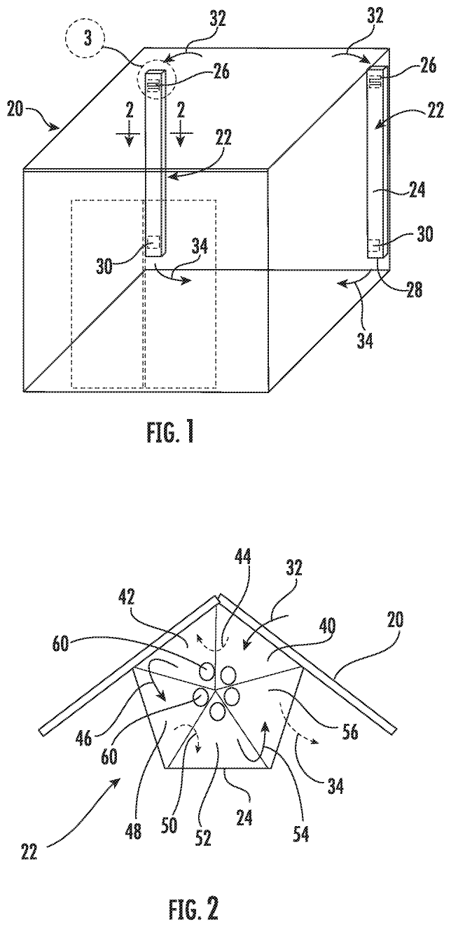

FIG. 1 diagrammatically illustrates selected portions of an elevator cab 20. A plurality of air purification devices 22 are situated within the elevator cab 20. Each of the exemplary air purification devices 22 includes a housing 24 having an inlet 26 and an outlet 28. A fan module 30 causes airflow into the inlet 26, through a plurality of pathways within the housing 24 and out of the housing 24 through the outlet 28. The illustrated position of the fan module shown in FIG. 1 is for ease of illustration and not limiting in any way. The fan module 30 includes at least one fan. Multiple fans may be positioned in different locations along the housing 24 to achieve a desired airflow.

In the example of FIG. 1, air is drawn into the inlet 26 from near a ceiling of the elevator cab 22 as schematically represented by the arrows 32. Airflow exiting the outlet 28 is directed generally toward a floor of the elevator cab 20 as schematically shown by the arrows 34. In this example, the inlet 26 is located near the ceiling of the elevator cab 20 and the outlet 28 is located near the floor of the elevator cab 20 to take advantage of natural air convection within the elevator cab 20.

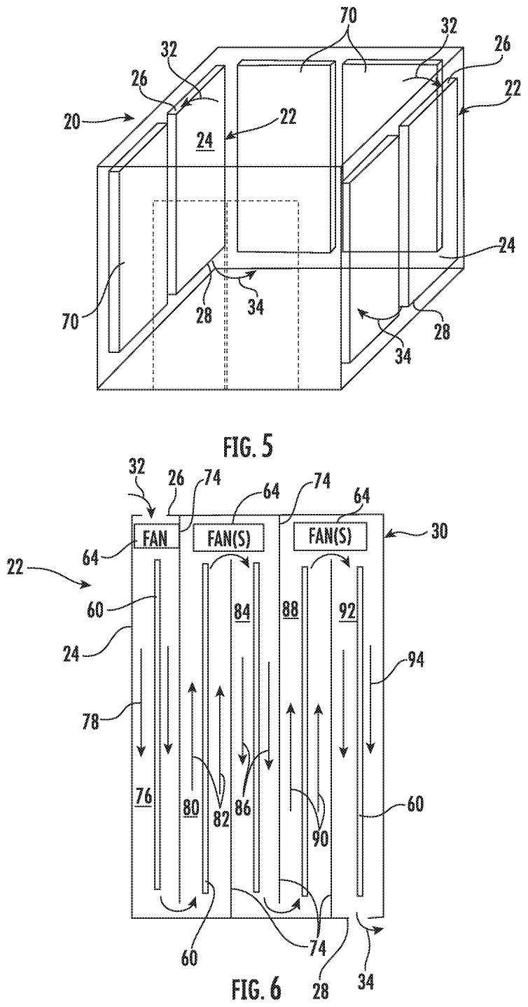

As can be appreciated from FIGS. 1 and 2, the air purification devices 22 in this example embodiment are configured to be received in a corner of the interior of the elevator cab 20. The housings 24 in this example include two sides configured to be received against and secured to the two walls that meet at the corresponding corner of the elevator cab 20. Other embodiments, such as that shown in FIG. 5, include housings that are configured to be situated along and secured to a wall of the elevator cab 20. The number and size of air purification devices 22 may vary to achieve sufficient purification for a particular cab size or expected occupancy during use.

In FIG. 2, the airflow arrows that are in broken lines represent airflow near a bottom of the housing 24 and the solid-line arrows represents airflow near a top of the housing 24. In this example embodiment, the housing includes a first pathway 40 extending from the inlet 26 toward a bottom of the housing 24. The air moves downward along the first pathway 40 in a downward direction (e.g., into the page in FIG. 2). Airflow leaves the first pathway 40 and continues along a second pathway 42 as schematically represented by the arrow 44. Airflow through the second pathway 42 is in an upward direction (e.g., out of the page according to FIG. 2).

The airflow continues as shown at 46 from the second pathway 42 into a third pathway 48. In this example, the air flows downward through the third pathway 48 and eventually transitions as shown by the arrow 50 into a fourth pathway 52. Airflow through the fourth pathway 52 is in an upward direction. The airflow eventually transitions as represented by the arrow 54 into a fifth pathway 56 from which it eventually exits the housing 24 through the outlet 28 as represented by the arrow 34.

Each of the pathways 40, 42, 48, 52 and 56 includes an air purifier that may comprise various features or components, such as a filter or a source of radiation. For purposes of discussion, the illustrated example embodiments include a source of radiation 60 as the air purifier. The source of radiation 60 irradiates the air flowing along the pathway. The sources of radiation 60 are situated to irradiate the air within each pathway to purify the air. According to this description, purified air has at least some contaminants removed from it. Air is purified even if less than all particles or contaminants are removed from the air. In other words, purified air is not necessarily absolutely pure but has a lower level of concentration of at least one type of contaminant compared to air that has not been purified by the purification device 22.

In an example embodiment, the sources of radiation 60 emit ultraviolet light so that air flowing along each pathway is irradiated by the ultraviolet radiation. In some embodiments, the sources of ultraviolet light include a plurality of light emitting diodes (LEDs). In an example embodiment, a flexible ribbon made of a silicone material supports a plurality of LEDs that emit ultraviolet light along the corresponding pathway within the housing 24. A silicone-based support for the LEDs is not subject to ultraviolet degradation and provides a small packaging envelope so that a useful amount of ultraviolet radiation affects the airflow in each passageway without requiring the air purification device 22 to take up a significant amount of space within the interior of the elevator cab 20.

The housing 24 retains the ultraviolet light or other purifying radiation and prevents it from emanating into the interior of the elevator cab. Only the air flowing along the pathways of the air purification device 22 is exposed to that radiation.

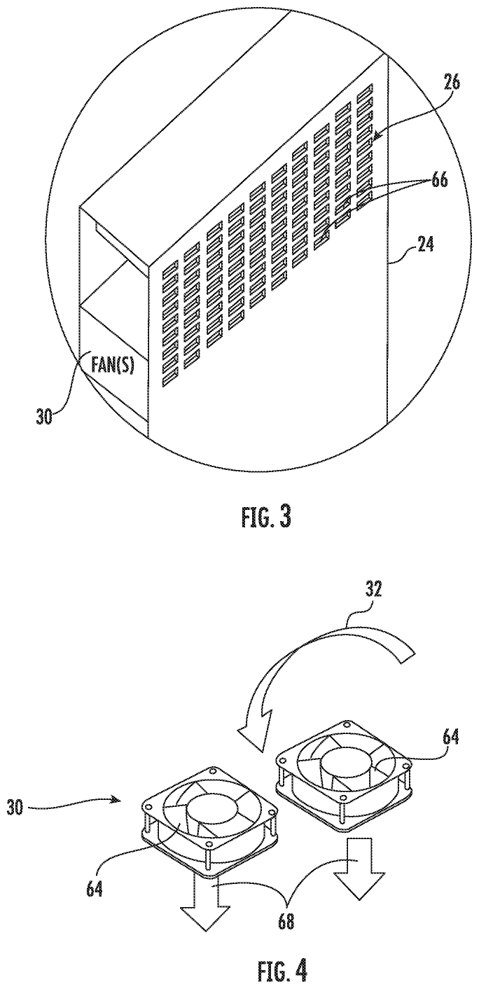

FIGS. 3 and 4 show an example configuration of a fan module 30. In this example, the fan module includes a plurality of fans 64 that draw air in through louver openings 66 of the inlet 26. The fans 64 then propel air or cause airflow as represented by the arrows 68 into at least one pathway within the housing 24. Other embodiments include a single fan that is capable of establishing the desired airflow throughout the entire air purification device 22.

FIGS. 5 and 6 illustrate another example embodiment. Raised panels 70 are provided for aesthetic purposes within the interior of the elevator cab 20. The air purification devices 22 in this example are configured to appear like raised panels, resembling the aesthetic raised panels 70. The housing 24 is configured as a raised panel or a relatively thin cabinet that is supported on a wall of the elevator cab 20. In this example, a plurality of baffles 74 are situated within the housing 24 to establish a plurality of airflow pathways.

As shown in FIG. 6, the fan module 30 includes multiple fans 64. At least one of the fans 64 draws air into the inlet 26 and causes airflow along a first pathway 76 as represented by the arrows 78. A source of radiation 60, such as a strip of LEDs is situated along a substantial portion of the length of the pathway 76 for irradiating the air flowing along the pathway 76.

The first pathway 76 in this example ends near a bottom of the housing 24 where the airflow continues around an end of the corresponding baffle 74 into a second pathway 80 that includes its own source of radiation 60. As represented by the arrows 82, the airflow through the second pathway 80 in this example is in an upward direction away from the floor of the elevator cab and toward the ceiling of the elevator cab. A third pathway 84 receives continued airflow that moves through the third pathway 84 in a downward direction as directed by the arrows 86. A fourth pathway 88 accommodates airflow as represented by the arrows 90 and a fifth pathway 92 accommodates airflow as represented by the arrows 94 toward the outlet 28 where the purified air exists the housing 24 as represented by the arrow 34.

The fans 64 of the fan module 30 are situated at various locations of the housing 24 in this example to achieve a desired air flow rate through the pathways. The fans 64 operate to establish a flow rate that ensures a desired amount of time that the air is exposed to the ultraviolet radiation to reduce or eliminate contaminants or pathogens in the air. In the illustrated example embodiments, the plurality of pathways and the different directions of airflow along those pathways provides a substantial enough time of exposure of the air to the ultraviolet radiation for effectively purifying the air flowing through the housing 24. In the illustrated example embodiments, the air purification devices 24 are taller than they are wide and, therefore, the airflow pathways are oriented in a vertical direction and the airflow is directed vertically between the ceiling and the floor in opposite directions along adjacent pathways.

In other embodiments, a serpentine arrangement of pathways in a generally horizontal orientation within a housing 24 accommodates airflow for a sufficient amount of time to provide adequate exposure to ultraviolet radiation for purifying the air.

The embodiments described above can be retrofit into existing elevator cabs without disrupting the aesthetic of the interior of the cab. Those and other embodiments are useful for new cabs or fully renovated cab interiors. Some embodiments intended to be incorporated into a new cab or new cab interior include a housing that extends from the decorative ceiling area to the kickplate area. The air purification device is embedded into the exterior of the shell, in a fashion similar to arrangement of the embodiment shown in FIGS. 5 and 6. The air purification device of such embodiments is embedded into the shell panel, itself.

Air purification devices 22 like those in the disclosed example embodiments, facilitate purifying air within an elevator cab 20. Such devices are useful, for example to reduce or eliminate airborne pathogens or contaminants, such as the COVID-19 virus or other communicable diseases. The air purification devices 22 fit within an elevator cab 20 in a manner that does not reduce the passenger-carrying capacity in most instances. The air purification devices 22 can be incorporated into the interior of an elevator cab 20 without disrupting the aesthetics of the cab interior.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator cab air purification device, comprising:
a housing including an inlet, an outlet, and at least one air pathway between the inlet and the outlet;
a fan module that is situated to cause air flow into the housing through the inlet, through the housing, and out of the housing through the outlet, wherein the air flow through the housing includes air flow along the at least one pathway in at least a first direction; and
an air purifier situated within the housing and configured to purify air that flows along the at least one pathway to thereby purify the air before the air exits the housing through the outlet.

2. The device of claim 1, wherein the air purifier comprises a source of radiation.

3. The device of claim 1, wherein the source of radiation comprises a light that emits ultraviolet light.

4. The device of claim 3, wherein
the at least one pathway comprises a plurality of pathways;
the airflow through the housing includes airflow along at least one other of the pathways in a second, different direction; and
each of the pathways includes a light that emits the radiation along at least portion of a length of the pathway.

5. The device of claim 4, wherein the first direction is opposite the second direction.

6. The device of claim 5, wherein
the elevator cab includes a plurality of vertically oriented walls between a floor and a ceiling,
the housing is situated parallel to and against at least one of the walls,
the first direction corresponds to air flow away from the ceiling and toward the floor, and
the second direction corresponds to air flow away from the floor and toward the ceiling.

7. The device of claim 4, wherein the housing includes a plurality of baffles that define the pathways within the housing.

8. The device of claim 1, wherein
the fan module comprises a plurality of fans, and
at least one of the plurality of fans is situated in a different location of the housing than at least one others of the plurality of fans.

9. The device of claim 1, wherein the housing is configured to be situated against a corner of an interior of the elevator cab.

10. The device of claim 1, wherein the housing is configured as a portion of an interior cab wall, a raised panel or a cabinet.

11. A method of purifying air in an elevator cab using a housing including an inlet, an outlet, and at least one air pathway between the inlet and the outlet, the method comprising:
causing air flow into the housing through the inlet, through the housing, and out of the housing through the outlet, wherein the air flow through the housing includes air flow along at the least one pathway in at least a first direction; and
purifying air that flows along the at least one pathway before the air exits the housing through the outlet.

12. The method of claim 11, wherein purifying the air that flows along the at least one pathway comprises irradiating the air.

13. The method of claim 12, wherein irradiating the air comprises exposing the air to ultraviolet light.

14. The method of claim 13, wherein
the at least one pathway comprises a plurality of pathways;
the airflow through the housing includes airflow along at least one other of the pathways in a second, different direction; and
irradiating the air comprises exposing the air flow along each of the pathways to light along at least portion of a length of the pathway.

15. The method of claim 14, wherein the first direction is opposite the second direction.

16. The method of claim 15, wherein
the elevator cab includes a plurality of vertically oriented walls between a floor and a ceiling,
the housing is situated parallel to and against at least one of the walls,
the first direction corresponds to air flow away from the ceiling and toward the floor, and
the second direction corresponds to air flow away from the floor and toward the ceiling.

17. The method of claim 14, wherein the housing includes a plurality of baffles that define the pathways within the housing.

18. The method of claim 11, wherein
causing the air flow comprises using a fan module,
the fan module comprises a plurality of fans, and
at least one of the plurality of fans is situated in a different location of the housing than at least one others of the plurality of fans.

19. The method of claim 11, wherein the housing is configured to be situated against a corner of an interior of the elevator cab.

20. The method of claim 11, wherein the housing is configured as a portion of an interior cab wall, a raised panel or a cabinet.
